(19) United States
(12) Patent Application Publication
(10) Pub. No.: US 2007/0185287 A1
(43) Pub. Date: Aug. 9, 2007

(54) Modified epoxy resin, process for its production, photosensitive resin composition and photsensitive element

(76) Inventors: Shuuichi Itagaki, Ibaraki (JP); Katsunori Tsuchiya, Ibaraki (JP); Tetsuya Yoshida, Ibaraki (JP); Katsusige Tsukada, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/566,474

(22) PCT Filed: Jul. 2, 2004
(86) PCT No.: PCT/JP04/09439

§ 371 Date: Jun. 30, 2006

(30) Foreign Application Priority Data
Jul. 31, 2003 (JP) 2003-284424
Mar. 12, 2004 (JP) 2004-071349

(51) Int. Cl. C08L 63/02

(52) U.S. Cl. 525/524; 525/529; 525/528

(57) ABSTRACT

A modified epoxy resin containing a repeating unit represented by the following general formula (1): 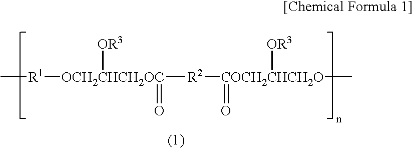
[wherein R¹ represents a divalent organic group which is a diglycidyl ether-type epoxy compound residue, R² represents a divalent organic group which is a dibasic acid residue, R³ represents a hydrogen atom or a group represented by the following general formula (2): 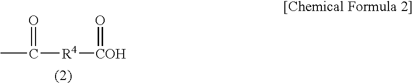
(wherein R⁴ represents an acid anhydride residue), and n represents an integer of 1 or greater].

### TECHNICAL FIELD

The present invention relates to a modified epoxy resin, a process for its production, a photosensitive resin composition and a photosensitive element.

### BACKGROUND ART

Film-like printed circuit boards, known as flexible printed circuit (hereinafter abbreviated as FPC) boards, have conventionally been used in miniature devices such as cameras, magnetic heads, cellular phones and the like. Because FPC boards retain their function even when bent, they are particularly suited as printed circuit boards for use in such miniature devices. In recent years, especially, with increasing demands for even smaller and lighter-weight electronic devices, FPC boards for device circuits have been employed in order to realize reduced dimensions and weight for miniature devices, as well as lower production costs and design simplification.

The solder resists used in FPC boards must exhibit properties including developing properties, high resolution, insulation, soldering heat resistance and plating resistance, similar to solder resists used in ordinary printed circuit boards, but must also have flexibility to prevent breakage when the FPC boards are bent.

At the current time, the most commonly employed solder resists for FPC boards are cover lays formed by punching out an adhesive-attached polyimide film, because these generally satisfy the various properties mentioned above. However, such cover lays are associated with increased cost because of the very high expense of dies used for die cutting, and because positioning and attachment must be done manually during lamination of the cover lays. In addition, even though FPC boards are used to satisfy demands for smaller electronic devices, providing cover lay solder resists on FPC boards is problematic because it hampers formation of fine patterns.

In order to solve these problems, there have been proposed liquid FPC ink compositions comprising an unsaturated group-containing polycarboxylic acid resin obtained by reacting the addition product of a specific epoxy resin and an unsaturated monocarboxylic acid with succinic anhydride (for example, see Patent documents 1 and 2).

There has also been proposed a liquid photosensitive resin composition characterized by comprising the reaction product of a polybasic acid or the like and a product obtained by reacting a mixture of a novolac-epoxy resin and a rubber-modified bisphenol A-type epoxy resin with an ethylenic unsaturated carboxylic acid, which is intended for formation of a flexible solder resist.

[Patent document 1] Japanese Unexamined Patent Publication HEI No. 7-207211

[Patent document 2] Japanese Unexamined Patent Publication HEI No. 8-134390

[Patent document 3] Japanese Unexamined Patent Publication HEI No. 9-5997

### DISCLOSURE OF THE INVENTION

### Problems to be Solved by the Invention

However, upon detailed investigation of conventional liquid FPC ink compositions and photosensitive resin compositions, including those described in the aforementioned patent documents, the present inventors found that film formability is impaired if the modified epoxy resin used has a weight-average molecular weight of 10,000 or less. Specifically, the present inventors found that using films of these compositions to form FPC boards and the like leads to sticking of the films and thus reduced manageability.

Moreover, the present inventors discovered that when the weight-average molecular weights of the modified epoxy resins in these compositions are 50,000 or greater, the final resist films obtained using the compositions have reduced storage stability. Also, whereas ordinary photosensitive resin compositions are coated onto printed circuit boards, partially cured and then developed with a dilute aqueous alkali solution for separation and removal of the uncured portions, it was found that even after the compositions described in the aforementioned patent documents are cured and treated with a dilute aqueous alkali solution for development, the uncured portions are inadequately separated and removed if the weight-average molecular weight of the modified epoxy resin is 50,000 or greater.

The present invention has been accomplished in light of these circumstances, and its object is to provide a modified epoxy resin that can be used to prepare a photosensitive resin composition capable of simultaneously satisfying the properties required of permanent masks formed on film-like base materials such as FPC cover lays (especially photosensitivity, resolution, film formability, soldering heat resistance, plating resistance and flexibility), as well as a process for its production and a photosensitive resin composition comprising it. It is another object of the invention to provide a photosensitive element comprising the photosensitive resin composition.

### MEANS FOR SOLVING THE PROBLEMS

As a result of much diligent research directed toward achieving the aforestated object, the present inventors have found that this object can be achieved by adding a modified epoxy resin with a specific structure to a photosensitive resin composition, and have thereupon completed the present invention.

Specifically, the modified epoxy resin of the present invention is characterized by containing a repeating unit represented by the following general formula (1): 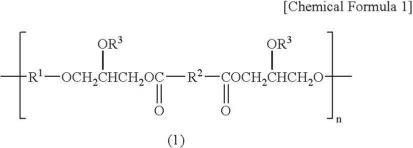
In this formula, R¹ represents a divalent organic group which is a diglycidyl ether-type epoxy compound residue, R² represents a divalent organic group which is a dibasic acid residue, R³ represents a hydrogen atom or a group represented by the following general formula (2): 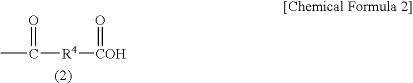
and n represents an integer of 1 or greater. In formula (2), R⁴ represents an acid anhydride residue. Throughout the present specification, “modified epoxy resin” refers to a resin obtained by modifying an epoxy compound (epoxy resin), regardless of whether or not the “modified epoxy resin” itself contains an epoxy group (glycidyl group).

Also, “diglycidyl ether-type epoxy compound” means a compound represented by the following general formula (4): 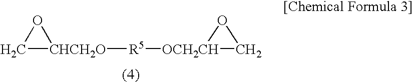
where R⁵ represents a divalent organic group.

The modified epoxy resin is represented, for example, by the following general formula (3): 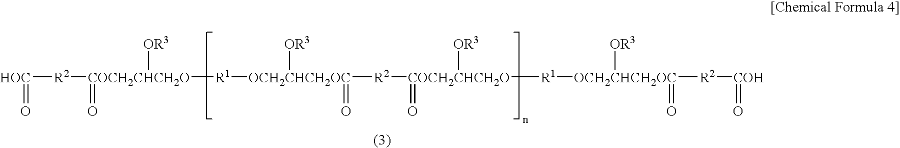
In formula (3), R¹ represents a divalent organic group which is a diglycidyl ether-type epoxy compound residue, R² represents a divalent organic group which is a dibasic acid residue, R³ represents a hydrogen atom or a group represented by general formula (2) above, and n represents an integer of 1 or greater.

The modified epoxy resin of the invention is obtained by a production process for a modified epoxy resin which comprises a first step of obtaining an intermediate product by polymerization reaction between a diglycidyl ether-type epoxy compound and a dibasic acid, and a second step of adding an acid anhydride to the intermediate product.

It is expected that this type of modified epoxy resin should tend to be resistant to gelling because it has ester-type linear bonds and the molecule tends to have an overall linear structure. Thus, a photosensitive element provided with a photosensitive resin composition layer formed from a photosensitive resin composition comprising such a modified epoxy resin allows satisfactory development with dilute aqueous alkali solutions when forming the resist film.

Among the modified epoxy resins obtained in the manner described above, modified epoxy resins comprising a dicarboxylic acid as the dibasic acid, and having a linear structure due to ester bonds produced by reaction between carboxyl groups and glycidyl groups in the molecule, are preferred because they tend to exhibit excellent alkali development properties.

A modified epoxy resin having such a structure may have at least one carboxyl group, and preferably has a weight-average molecular weight of 10,000-70,000. This will tend to further improve the film formability and the dilute aqueous alkali solution development properties of the photosensitive resin composition comprising the modified epoxy resin.

The modified epoxy resin preferably has an acid value of 70-200 mgKOH/g. This will tend to improve the electrical insulating property, chemical resistance and plating resistance of cured films obtained from the photosensitive resin composition comprising the modified epoxy resin.

The process for production of a modified epoxy resin of the invention is characterized by comprising a first step of obtaining an intermediate product by polymerization reaction between a diglycidyl ether-type epoxy compound and a dibasic acid, and a second step of adding an acid anhydride to the intermediate product to obtain a modified epoxy resin. The modified epoxy resin produced in this manner can form an ester bond linear structure, an ether bond crosslinking structure or an ester bond crosslinking structure in the molecule, in order to allow adjustment of the alkali development property.

Using a dicarboxylic acid as the dibasic acid is preferred in order to exhibit a more notable effect.

In the production process for the epoxy resin, it is preferred to use a tertiary amine with pKa of no greater than 9.0 as the catalyst for the polymerization reaction. This will tend to improve the development property of the resist film formed using the resin in dilute aqueous alkali solutions. “Ka” represents the acid dissociation constant, and “pKa” is a numerical value defined by pKa=−log(Ka).

The invention further provides a photosensitive resin composition characterized by comprising (A) the aforementioned modified epoxy resin, (B) a photopolymerizable compound having at least one ethylenic unsaturated group in the molecule, and (C) a photopolymerization initiator.

The photosensitive resin composition has the essential components (A) to (C) mentioned above, and is therefore capable of simultaneously satisfying the properties required of permanent masks formed on film-like base materials such as FPC cover lays (especially photosensitivity, resolution, film formability, soldering heat resistance, plating resistance and flexibility), thereby allowing enhancement of the photosensitive element characteristics and more efficient production of high-resolution, high-density printed circuit boards.

The photosensitive resin composition of the invention preferably also comprises (D) a resin with an unsaturated group, obtained by polymerization of (a) a resin obtained by copolymerization of a (meth)acrylic acid ester monomer and a monomer with a prescribed functional group (I), and (b) a compound with a prescribed functional group (II) and an unsaturated group, by reaction between the functional group (I) and functional group (II).

By further including component (D) mentioned above, it is possible to additionally improve the flexibility of the photosensitive resin composition, and more reliably obtain a photosensitive resin composition with plating resistance.

The functional group (I) is preferably at least one selected from the group consisting of hydroxyl, carboxyl, epoxy and isocyanate.

The monomer containing the functional group (I) is preferably at least one selected from the group consisting of 2-hydroxyethyl (meth)acrylate, 2-hydroxypropyl (meth)acrylate, 4-hydroxybutyl (meth)acrylate, phenylglycidyl ether (meth)acrylate, (meth)acrylic acid, itaconic acid, β-(meth)acryloyloxyethylhydrogen succinate, glycidyl (meth)acrylate, (meth)allylglycidyl ether, vinyl isocyanate, (meth)acryl isocyanate and 2-(meth)acryloyloxyethyl isocyanate.

The functional group (II) is preferably at least one selected from the group consisting of aldehyde, hydroxyl, ethyleneimino, carboxyl, epoxy and isocyanate.

The unsaturated group of (II) the (b) compound with a prescribed functional group (II) and an unsaturated group is preferably at least one selected from the group consisting of vinyl, isopropenyl, (meth)allyl and (meth)acryloyl.

The combination of the functional group (I) and functional group (II) is preferably a combination selected from the group consisting of hydroxyl and isocyanate, hydroxyl and epoxy, hydroxyl and aldehyde, hydroxyl and carboxyl, hydroxyl and ethyleneimino, carboxyl and epoxy, carboxyl and hydroxyl, isocyanate and hydroxyl, and epoxy and carboxyl.

The glass transition temperature of the (D) resin with an unsaturated group is preferably −10 to 60° C., the weight-average molecular weight is preferably 10,000-200,000 and the acid value is preferably 50-150 mgKOH/g. This will tend to result in further enhanced electrical insulating properties, chemical resistance and plating resistance of cured films of the photosensitive resin composition.

From the standpoint of more easily and reliably achieving the effect of the invention when the photosensitive resin composition of the invention contains component (D), the aforementioned component (A) is preferably a modified epoxy resin represented by the following general formula (3): 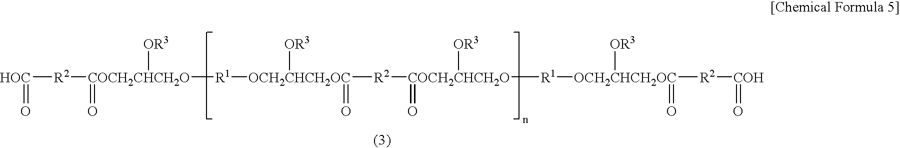
In formula (3), R¹ represents a divalent organic group which is a diglycidyl ether-type epoxy compound residue, R² represents a divalent organic group which is a dibasic acid residue, R³ represents a hydrogen atom or a group represented by general formula (2) above, and n represents an integer of 1 or greater.

The photosensitive resin composition of the invention described above can be used to form a flexible cured resin on a film-like base material. Thus, by curing the photosensitive resin composition and using it as a permanent mask for an FPC, it is possible to prevent breakage of the permanent mask even when the FPC is bent.

The invention further provides a photosensitive element characterized by comprising a support and a photosensitive resin composition layer composed of a photosensitive resin composition such as described above formed on the support.

By using such a photosensitive element exhibiting excellent development properties, high resolution, soldering heat resistance, plating properties and flexibility, it is possible to efficiently manufacture high-resolution, high-density printed circuit boards.

### EFFECT OF THE INVENTION

According to the present invention, it is possible to provide a modified epoxy resin that can be used to prepare a photosensitive resin composition capable of simultaneously satisfying the properties required of permanent masks formed on film-like base materials such as FPC cover lays (especially photosensitivity, resolution, film formability, soldering heat resistance, plating resistance and flexibility), as well as a process for its production and a photosensitive resin composition comprising it. According to the invention it is also possible to provide a photosensitive element comprising the photosensitive resin composition.

### BRIEF DESCRIPTION OF THE DRAWINGS

FIG. 1 is a diagram showing the IR spectrum for a modified epoxy resin obtained in the examples.

### BEST MODE FOR CARRYING OUT THE INVENTION

Preferred modes of the invention will now be explained in detail.

“(Meth)acrylic acid” according to the invention refers to an acrylic acid compound or its corresponding methacrylic acid compound, “(meth)acrylate” refers to an acrylate or its corresponding methacrylate, “(meth)acryloyl” refers to an acryloyl or its corresponding methacryloyl compound, and “(meth)acryloxy” refers to an acryloxy or its corresponding methacryloxy compound.

The modified epoxy resin of the invention contains a repeating unit represented by the following general formula (1): 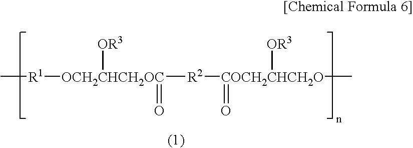
In formula (1), R¹ represents a diglycidyl ether-type epoxy compound residue, R² represents a dibasic acid residue, R³ represents a hydrogen atom or a group represented by the following general formula (2): 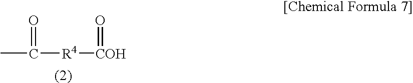
and n represents an integer of 1 or greater. In formula (2), R⁴ represents an acid anhydride residue. The modified epoxy resin may be one represented by the following general formula (3), for example:

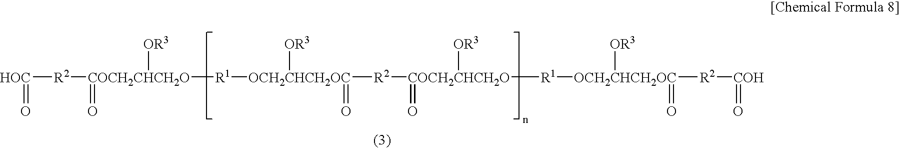

The weight-average molecular weight (Mw) of the aforementioned modified epoxy resin may be measured by gel permeation chromatography (GPC) (in terms of standard polystyrene). The Mw of the epoxy resin obtained by this measuring method is preferably 10,000-70,000, more preferably 25,000-60,000 and even more preferably 30,000-50,000, from the viewpoint of film formability (sticking resistance) and development in dilute aqueous alkali solutions.

The upper limit for n in the structural formula of the modified epoxy resin represented by general formula (1) above may vary appropriately depending on the types of residues for R¹, R², R³ and R⁴, but the upper limit for n is preferably established as the value at which the weight-average molecular weight is 70,000.

The acid value of the modified epoxy resin may be measured by the following method. First, approximately 1 g of a solution of the modified epoxy resin of the invention is prepared, and 30 g of acetone is added to the resin solution to uniform dissolution. Next, a suitable amount of phenolphthalein (as an indicator) is added to the solution, and a 0.1 N aqueous KOH solution is used for titration. From the measurement results it is possible to calculate the acid value based on the following general formula (5):
A=10×Vf×56.1/(Wp×I) (5)
In this formula, A represents the acid value (mgKOH/g), Vf represents the phenolphthalein titer (mL), Wp represents the modified epoxy resin solution weight (g) and I represents the proportion of the non-volatile portion of the modified epoxy resin solution (wt %).

The acid value of the modified epoxy resin determined by this measurement method is preferably 70-200 mgKOH/g, more preferably 80-180 mgKOH/g and even more preferably 90-160 mgKOH/g, from the viewpoint of development in dilute aqueous alkali solutions and the electrical insulating property, chemical resistance and plating resistance of the obtained cured film.

The process for production of the aforementioned modified epoxy resin will now be explained.

The process for production of the modified epoxy resin comprises a first step of obtaining an intermediate product by polymerization reaction between a diglycidyl ether-type epoxy compound having two glycidyl groups in the molecule and a dibasic acid, and a second step of adding an acid anhydride to the intermediate product to obtain the aforementioned modified epoxy compound.

The diglycidyl ether-type epoxy compound residue represented by R¹ in general formula (1) above is the portion of the diglycidyl ether-type epoxy compound structure minus the glycidyl group. The dibasic acid residue represented by R² in general formula (1) above is the portion of the dibasic acid compound structure minus the dibasic acid functional group.

(First Step)

There are no particular restrictions on the diglycidyl ether-type epoxy compound used as the starting material for the first step, but it preferably also has at least one phenoxy group in the molecule and even more preferably at least two phenoxy groups in the molecule.

As examples of diglycidyl ether-type epoxy compounds there may be mentioned bisphenol A-type epoxy resins such as bisphenol A diglycidyl ether, bisphenol F-type epoxy resins such as bisphenol F diglycidyl ether, bisphenol S-type epoxy resins such as bisphenol S diglycidyl ether, biphenol-type epoxy resins such as biphenol diglycidyl ether, bixylenol-type epoxy resins such as bixylenol diglycidyl ether, hydrogenated bisphenol A-type epoxy resins such as hydrogenated bisphenol A diglycidyl ether, and their dibasic acid-modified diglycidyl ether-type epoxy resins. Among these, bisphenol A-type epoxy resins are preferred because of their excellent heat resistance and chemical resistance, and their relatively low shrinkage when cured. These may be used alone or in combinations of two or more.

Commercially available forms of these compounds may be used. For example, as bisphenol A diglycidyl ethers there may be mentioned EPIKOTE 828, EPIKOTE 1001 and EPIKOTE 1002 (all trade names of Japan Epoxy Resins). As bisphenol F diglycidyl ethers there may be mentioned EPIKOTE 807 (trade name of Japan Epoxy Resins) and the like, and as bisphenol S diglycidyl ethers there may be mentioned EBPS-200 (trade name of Nippon Kayaku Co., Ltd.) and EPICLON EXA-1514 (trade name of Dainippon Ink & Chemical Co., Ltd.). As a biphenol diglycidyl ether there may be mentioned YL-6121 (trade name of Japan Epoxy Resins), and as a bixylenol diglycidyl ether there may be mentioned YX-4000 (trade name of Japan Epoxy Resins). As hydrogenated bisphenol A diglycidyl ethers there may be mentioned ST-2004 and ST-2007 (both trade names of Tohto Kasei Co., Ltd.), and as dibasic acid-modified diglycidyl ethers there may be mentioned ST-5100 and ST-5080 (both products of Tohto Kasei Co., Ltd.).

The epoxy equivalent (gram weight of the compound containing an equivalent of epoxy groups) of each of these diglycidyl ether-type epoxy compounds can be measured by JIS K 7236 “Method of Determining Epoxy Equivalent Weight of Epoxy Resins”. The epoxy equivalent of the epoxy compound as determined by this measuring method is preferably 160-3300 and more preferably 180-980 from the viewpoint of development in dilute aqueous alkali solutions.

As dibasic acid compounds there are preferred dicarboxylic acids, of which specific examples include maleic acid, succinic acid, phthalic acid, tetrahydrophthalic acid, methyltetrahydrophthalic acid, hexahydrophthalic acid, methylhexahydrophthalic acid, endomethylenetetrahydrophthalic acid and methylendomethylenetetrahydrophthalic acid. Tetrahydrophthalic acid is preferred among these dibasic acids. These may be used either alone or in combinations of two or more.

The polymerization reaction of the first step may be carried out by an ordinary method. The mixing ratio of the diglycidyl ether-type epoxy compound and the dibasic acid is preferably 1.03-1.30, expressed as the functional group equivalent (carboxyl group/epoxy group) ratio, from the standpoint of the molecular weight of the modified epoxy resin, the development property in dilute aqueous alkali solutions, storage stability and film formability.

The catalyst used in the polymerization reaction of the first step may be, for example, a phosphine, an alkaline metal compound, an amine or the like. As specific examples there may be mentioned phosphines such as tributylphosphine and triphenylphosphine, alkaline metal compounds such as sodium hydroxide, lithium hydroxide and potassium hydroxide, and amines such as triethanolamine, N,N′-dimethylpiperazine, triethylamine, tri-n-propylamine, hexamethylenetetramine, pyridine and tetramethylammonium bromide. These may be used either alone or in combinations of two or more.

Preferred among these as the catalyst used in the polymerization reaction of the first step are tertiary amines having a pKa of no greater than 9.0, and more preferably tertiary amines having a pKa of no greater than 7.3. By using such a catalyst it is possible, ultimately, to selectively synthesize a modified epoxy resin represented by general formula (1) above. Of the specific catalysts mentioned above, there are preferably used ones other than phosphines and alkaline metal compounds, or tertiary amines having a pKa of no greater than 9.0, from the standpoint of preventing gelling due to bond types (ether-type crosslinking bonds and/or ester-type crosslinking bonds) in the obtained modified epoxy resin.

The intermediate product resulting from the polymerization reaction of the first step described above can form in the molecule a linear structure by the ester bonds produced by reaction between the carboxyl groups and glycidyl groups, a crosslinked structure by the ether bonds produced by reaction between the hydroxyl groups and glycidyl groups, and a crosslinked structure by the ester bonds produced by reaction between the hydroxyl groups and carboxyl groups. When the obtained intermediate product has in the molecule an extensive crosslinked structure by ether bonds and an extensive crosslinked structure by ester bonds, it will presumably tend to form a three-dimensional structure overall. Thus, since the intermediate product and the modified epoxy resin obtained after the second step described hereunder tend to gel, the uncured portions of the resist film formed from such a resin will generally be unremovable even by development using a dilute aqueous alkali solution.

On the other hand, the intermediate product synthesized using a catalyst as described above may be subjected to the second step to obtain a modified epoxy resin having numerous linear ester bonds in the molecule and having an overall linear structure, such as a compound represented by general formula (1), thereby tending to prevent gelling. Consequently, the uncured portions of a resist film formed using this type of modified epoxy resin are easily removed by development using a dilute aqueous alkali solution.

The amount of catalyst used is preferably 1-10 parts by weight to 100 parts by weight of the total amount of the glycidyl ether-type epoxy compound and dibasic acid, from the viewpoint of the polymerization reaction rate as well as the heat resistance and electrical insulating property of the cured film obtained from the photosensitive resin composition.

The reaction temperature for the first step is preferably 100-150° C. from the viewpoint of the polymerization reaction rate and preventing secondary reactions.

(Second Step)

In the second step, the intermediate product from the first step is reacted with an acid anhydride to produce a modified epoxy resin.

The acid anhydride residue represented by R⁴ in general formula (2) above is the portion of the acid anhydride compound structure minus the acid anhydride functional group.

As examples of acid anhydride compounds there may be mentioned dibasic acid anhydrides such as maleic anhydride, succinic anhydride, itaconic anhydride, phthalic anhydride, tetrahydrophthalic anhydride, hexahydrophthalic anhydride, methylhexahydrophthalic anhydride, endomethylenetetrahydrophthalic anhydride, methylendomethylenetetrahydrophthalic anhydride, chlorendic anhydride and methyltetrahydrophthalic anhydride, aromatic polyvalent carboxylic acid anhydrides such as trimellitic anhydride, pyromellitic anhydride and benzophenonetetracarboxylic dianhydride, as well as polyvalent carboxylic acid anhydride derivatives including polyvalent carboxylic anhydrides such as 5-(2,5-dioxotetrahydrofuryl)-3-methyl-3-cyclohexene-1,2-dicarboxylic anhydride, which are added thereto.

Among these, the use of dibasic acid anhydrides are preferred and the use of dicarboxylic acid anhydrides are more preferred. These may be used alone or in combinations of two or more.

The amount of acid anhydride added is preferably 0.6-1.3, expressed as the functional group equivalent (acid anhydride groups in added acid anhydride/hydroxyl groups of intermediate product produced in first step) ratio, from the standpoint of the development property in dilute aqueous alkali solutions and from the standpoint of heat resistance and electrical insulating property of the finally obtained cured film.

The reaction temperature for the second step is preferably 80-130° C. from the standpoint of the reaction rate and preventing secondary reactions

The production process comprising these first and second steps can produce a modified epoxy resin having a repeating unit represented by general formula (1) above, and for example, one represented by general formula (3) above.

A suitable solvent is commonly used in the production process for the modified epoxy resin. As specific examples there may be mentioned ketone compounds such as methyl isobutyl ketone, cyclohexanone or methylcyclohexanone, aromatic hydrocarbon compounds such as toluene, xylene or tetramethylbenzene, glycol ether compounds such as cellosolve, methylcellosolve, butylcellosolve, carbitol, methylcarbitol, butylcarbitol, propyleneglycol monomethyl ether, dipropyleneglycol monomethyl ether, dipropyleneglycol diethyl ether or triethyleneglycol monoethyl ether, ester compounds such as acetic acid esters of the aforementioned glycol ether compounds, alcohol compounds such as ethylene glycol or propylene glycol, or petroleum-based solvents such as petroleum ether, petroleum naphtha, hydrogenated petroleum naphtha or solvent naphtha.

The modified epoxy resin of the invention obtained in this manner is used by, for example, addition to a photosensitive resin composition. The photosensitive resin composition comprises, in addition to the aforementioned modified epoxy resin (component (A)), also (B) a photopolymerizable compound having at least one ethylenic unsaturated group in the molecule, and (C) a photopolymerization initiator.

As examples of photopolymerizable compounds having at least one ethylenic unsaturated group in the molecule as component (B) (hereinafter referred to simply as “photopolymerizable compound”) there may be mentioned bisphenol A-type (meth)acrylate compounds; compounds obtained by reacting α,β-unsaturated carboxylic acids with polyhydric alcohols; compounds obtained by reacting α,β-unsaturated carboxylic acids with glycidyl group-containing compounds; and urethane monomers or urethane oligomers, such as urethane bond-containing (meth)acrylate compounds. Additional examples include nonylphenoxypolyoxyethylene acrylate; phthalic acid-based compounds such as γ-chloro-β-hydroxypropyl-β′-(meth)acryloyloxyethyl-o-phthalate and β-hydroxyalkyl-β′-(meth)acryloyloxyalkyl-o-phthalate; (meth)acrylic acid alkyl esters and EO-modified nonylphenyl (meth)acrylates. These may be used alone or in combinations of two or more.

As examples of bisphenol A-type (meth)acrylate compounds there may be mentioned 2,2-bis(4-((meth)acryloxypolyethoxy)phenyl)propanes, 2,2-bis(4-((meth)acryloxypolypropoxy)phenyl)propanes, 2,2-bis(4 ((meth)acryloxypolybutoxy)phenyl)propanes and 2,2-bis(4-((meth)acryloxypolyethoxypolypropoxy)phenyl)propanes.

As examples of 2,2-bis(4-((meth)acryloxypolyethoxy)phenyl)propanes there may be mentioned 2,2-bis(4-((meth)acryloxydiethoxy)phenyl)propane, 2,2-bis(4-((meth)acryloxytriethoxy)phenyl)propane, 2,2-bis(4-((meth)acryloxytetraethoxy)phenyl)propane, 2,2-bis(4-((meth)acryloxypentaethoxy)phenyl)propane, 2,2-bis(4-((meth)acryloxyhexaethoxy)phenyl)propane, 2,2-bis(4-((meth)acryloxyheptaethoxy)phenyl)propane, 2,2-bis(4-((meth)acryloxyoctaethoxy)phenyl)propane, 2,2-bis(4-((meth)acryloxynonaethoxy)phenyl)propane, 2,2-bis(4-((meth)acryloxydecaethoxy)phenyl)propane, 2,2-bis(4-((meth)acryloxyundecaethoxy)phenyl)propane, 2,2-bis(4-((meth)acryloxydodecaethoxy)phenyl)propane, 2,2-bis(4-((meth)acryloxytridecaethoxy)phenyl)propane, 2,2-bis(4-((meth)acryloxytetradecaethoxy)phenyl)propane, 2,2-bis(4-((meth)acryloxypentadecaethoxy)phenyl)propane and 2,2-bis(4-((meth)acryloxyhexadecaethoxy)phenyl)propane, among which 2,2-bis(4-(methacryloxypentaethoxy)phenyl)propane is commercially available as BPE-500 (trade name of Shin-Nakamura Chemical Co., Ltd.), and 2,2-bis(4-(methacryloxypentadecaethoxy)phenyl)propane is commercially available as BPE-1300 (trade name of Shin-Nakamura Chemical Co., Ltd.). These may be used alone or in combinations of two or more.

As examples of 2,2-bis(4-((meth)acryloxypolypropoxy)phenyl)propanes there may be mentioned 2,2-bis(4-((meth)acryloxydipropoxy)phenyl)propane, 2,2-bis(4-((meth)acryloxytripropoxy)phenyl)propane, 2,2-bis(4-((meth)acryloxytetrapropoxy)phenyl)propane, 2,2-bis(4-((meth)acryloxypentapropoxy)phenyl)propane, 2,2-bis(4-((meth)acryloxyhexapropoxy)phenyl)propane, 2,2-bis(4-((meth)acryloxyheptapropoxy)phenyl)propane, 2,2-bis(4-((meth)acryloxyoctapropoxy)phenyl)propane, 2,2-bis(4-((meth)acryloxynonapropoxy)phenyl)propane, 2,2-bis(4-((meth)acryloxydecapropoxy)phenyl)propane, 2,2-bis(4-((meth)acryloxyundecapropoxy)phenyl)propane, 2,2-bis(4-((meth)acryloxydodecapropoxy)phenyl)propane, 2,2-bis(4-((meth)acryloxytridecapropoxy)phenyl)propane, 2,2-bis(4-((meth)acryloxytetradecapropoxy)phenyl)propane, 2,2-bis(4-((meth)acryloxypentadecapropoxy)phenyl)propane and 2,2-bis(4-((meth)acryloxyhexadecapropoxy)phenyl)propane. These may be used alone or in combinations of two or more.

As examples of 2,2-bis(4-((meth)acryloxypolyethoxypolypropoxy)phenyl)propanes there may be mentioned 2,2-bis(4-((meth)acryloxydiethoxyoctapropoxy)phenyl)propane, 2,2-bis(4-((meth)acryloxytetraethoxytetrapropoxy)phenyl)propane and 2,2-bis(4-((meth)acryloxyhexaethoxyhexapropoxy)phenyl)propane. These may be used alone or in combinations of two or more.

As examples of compounds obtained by reaction of α,β-unsaturated carboxylic acids with polyhydric alcohols there may be mentioned those using (meth)acrylic acid as the α,β-unsaturated carboxylic acid. Specifically, there may be mentioned polyethyleneglycol di(meth)acrylates with 2-14 ethylene groups, polypropyleneglycol di(meth)acrylates with 2-14 propylene groups, polyethylene/polypropylene glycol di(meth)acrylates with 2-14 ethylene groups and 2-14 propylene groups, trimethylolpropane di(meth)acrylate, trimethylolpropane tri(meth)acrylate, EO-modified trimethylolpropane tri(meth)acrylate, PO-modified trimethylolpropane tri(meth)acrylate, EO-PO-modified trimethylolpropane tri(meth)acrylate, tetramethylolmethane tri(meth)acrylate, tetramethylolmethane tetra(meth)acrylate, dipentaerythritol penta(meth)acrylate and dipentaerythritol hexa(meth)acrylate. These may be used alone or in combinations of two or more.

Here, “EO” refers to “ethylene oxide”, and “PO” refers to “propylene oxide”. “EO-modified” means that the compound has an ethylene oxide unit (—CH₂—CH₂—O—) block structure, and “PO-modified” means that the compound has a propylene oxide unit (—CH₂—CH(CH₃)—O—) block structure.

As examples of compounds obtained by reaction of α,β-unsaturated carboxylic acids with glycidyl group-containing compounds there may be mentioned those comprising (meth)acrylic acid as the α,β-unsaturated carboxylic acid. Specifically, there may be mentioned trimethylolpropane triglycidylether tri(meth)acrylate and 2,2-bis(4-(meth)acryloxy-2-hydroxy-propyloxy)phenyl.

As examples of urethane monomers there may be mentioned addition products of (meth)acrylic monomers having OH groups at the β position and diisocyanate compounds such as isophoronediisocyanate, 2,6-toluenediisocyanate, 2,4-toluenediisocyanate and 1,6-hexamethylenediisocyanate, tris((meth)acryloxytetraethyleneglycol isocyanate)hexamethylene isocyanurate, EO-modified urethane di(meth)acrylate, and EO- or PO-modified urethane di(meth)acrylate.

Also, as examples of (meth)acrylic acid alkyl esters there may be mentioned (meth)acrylic acid methyl ester, (meth)acrylic acid ethyl ester, (meth)acrylic acid butyl ester and (meth)acrylic acid 2-ethylhexyl ester.

These (B) components may be used alone or in combinations of two or more.

As examples of photopolymerization initiators for component (C) there may be mentioned aromatic ketones such as benzophenone, N,N′-tetramethyl-4,4′-diaminobenzophenone, 2-benzyl-2-dimethylamino-1-(4-morpholinophenyl)-butanone-1 and 2-methyl-1-[4-(methylthio)phenyl]-2-morpholino-propanone-1; quinones such as alkylanthraquinone; benzoin ether compounds such as benzoinalkyl ether; benzoin compounds such as benzoin and alkylbenzoin; benzyl derivatives such as benzyldimethylketal; 2,4,5-triarylimidazole dimer; acridine derivatives such as 9-phenylacridine and 1,7-bis(9,9′-acridinyl)heptane; N-phenylglycine, N-phenylglycine derivatives; coumarin-based compounds, and the like. These may be used alone or in combinations of two or more.

The content of component (A) in the photosensitive resin composition is preferably 30-70 parts by weight and more preferably 45-55 parts by weight with respect to 100 parts by weight as the total of component (A) and component (B), from the viewpoint of preventing bleed-out from the edges of the photosensitive film having the photosensitive resin composition layer, and from the viewpoint of soldering heat resistance and photosensitivity.

The content of component (B) is preferably 10-70 parts by weight and more preferably 35-55 parts by weight with respect to 100 parts by weight as the total of component (A) and component (B). If the content is less than 10 parts by weight, the photosensitivity will tend to be insufficient, and if it is greater than 70 parts by weight the photocured product will tend to be brittle.

The content of component (C) is preferably 0.1-20 parts by weight and more preferably 0.2-10 parts by weight with respect to 100 parts by weight as the total of component (A) and component (B), from the viewpoint of photosensitivity and soldering heat resistance.

The photosensitive resin composition of the invention preferably further comprises (D) a resin with an unsaturated group, obtained by polymerization of (a) a resin obtained by copolymerization of a (meth)acrylic acid ester monomer and a monomer with a prescribed functional group (I), and (b) a compound with a prescribed functional group (II) and an unsaturated group, by reaction between the functional group (I) and functional group (II). The resin of (a) is an acrylic-based resin and the resin of component (D) is an acrylic-based resin with an unsaturated group.

The glass transition temperature (Tg) of the resin with an unsaturated group as component (D) is preferably −10 to 60° C. and more preferably 10-45° C. By adjusting the glass transition temperature of the resin with an unsaturated group to be within this temperature range, the flexibility of the cured film obtained from the photosensitive resin composition of the invention will tend to be improved, while warping of the FPC board during formation of the cured film on the FPC board will tend to be reduced, and sticking of the coated film of the photosensitive resin composition will tend to be better suppressed.

The weight-average molecular weight (Mw) of the resin with an unsaturated group as component (D) may be measured by GPC (in terms of standard polystyrene). The Mw of the resin with an unsaturated group obtained by this measuring method is preferably 10,000-200,000 and more preferably 30,000-100,000, from the viewpoint of film formability (sticking resistance) and development in dilute aqueous alkali solutions.

The acid value of the resin with an unsaturated group as component (D) is preferably 50-150 mgKOH/g and more preferably 70-110 mgKOH/g, from the viewpoint of development in dilute aqueous alkali solutions and the electrical insulating property, chemical resistance and plating resistance of the obtained cured film.

As examples of (meth)acrylic acid ester monomers to be used as copolymerizing components to obtain the aforementioned (a) acrylic-based resin there may be mentioned methyl (meth)acrylate, ethyl (meth)acrylate, n-butyl (meth)acrylate, isobutyl (meth)acrylate, pentyl (meth)acrylate, hexyl (meth)acrylate, n-octyl (meth)acrylate, isoctyl(meth)acrylate, 2-ethylhexyl(meth)acrylate, decyl (meth)acrylate and dodecyl (meth)acrylate. These may be used alone or in combinations of two or more.

In addition to these (meth)acrylic acid ester monomers there may be used styrene-based monomers such as styrene, vinyltoluene and α-methylstyrene; (meth)acrylonitrile; (meth)acrylamide; and vinyl acetate. These may be used alone or in combinations of two or more.

As monomers having a functional group (I) to be used as copolymerizing components to obtain the (a) acrylic-based resin there may be mentioned monomers having unsaturated groups copolymerizable with (meth)acrylic acid ester monomers, and having at least one functional group (I).

As examples of the functional group (I) there may be mentioned hydroxyl, carboxyl, epoxy and isocyanate, among which hydroxyl and carboxyl are preferred.

As examples of monomers with hydroxyl groups there may be mentioned 2-hydroxyethyl (meth)acrylate, 2-hydroxypropyl (meth)acrylate, 4-hydroxybutyl (meth)acrylate and phenylglycidylether (meth)acrylate. As examples of monomers with carboxyl groups there may be mentioned (meth)acrylic acid, itaconic acid and β-(meth)acryloyloxyethylhydrogen succinate. As examples of monomers with epoxy groups there may be mentioned glycidyl (meth)acrylate and (meth)allylglycidyl ether. As examples of monomers with isocyanate groups there may be mentioned vinyl isocyanate, (meth)acryl isocyanate and 2-(meth)acryloyloxyethyl isocyanate. These monomers with a functional group (I) may be used alone or in combinations of two or more.

As examples of the aforementioned (b) compound having a functional group (II) and an unsaturated group there may be mentioned compounds having unsaturated groups such as vinyl, isopropenyl, (meth)allyl and (meth)acryloyl, and having at least one functional group (II) that can react with the functional group (I).

The functional group (II) may be selected from a variety of groups suitable for the functional group (I), which can react (bond) with the functional group (I). For example, when the functional group (I) is hydroxyl, examples of the functional group (II) which may be mentioned include isocyanate, epoxy, aldehyde, carboxyl and ethyleneimino. When the functional group (I) is carboxyl, examples of the functional group (II) which may be mentioned include epoxy and hydroxyl. When the functional group (I) is isocyanate, there may be mentioned hydroxyl as an example of the functional group (II). When the functional group (I) is epoxy, there may be mentioned carboxyl as the functional group (II).

As specific examples of the (b) compound having a functional group (II) and an unsaturated group there may be mentioned hydroxyl group-containing monomers such as 2-hydroxyethyl (meth)acrylate, 2-hydroxypropyl (meth)acrylate, 4-hydroxybutyl (meth)acrylate and phenylglycidylether (meth)acrylate; carboxyl group-containing monomers such as (meth)acrylic acid, itaconic acid and β-(meth)acryloyloxyethylhydrogen succinate; epoxy group-containing monomers such as glycidyl (meth)acrylate and (meth)allylglycidyl ether; isocyanate group-containing monomers such as vinyl isocyanate, (meth)acryl isocyanate and 2-(meth)acryloyloxyethyl isocyanate; aldehyde group-containing monomers such as (meth)acrolein; and ethyleneimine group-containing monomers such as 2-(1-aziridinyl)ethyl (meth)acrylate and 4-(1-aziridinyl)butyl (meth)acrylate. These compounds with functional groups (II) and unsaturated groups may be used alone or in combinations of two or more.

When the photosensitive resin composition described above further contains component (D), the content of component (A) in the photosensitive resin composition is preferably 30-60 parts by weight and more preferably 40-50 parts by weight with respect to 100 parts by weight as the total of components (A), (B) and (D), from the viewpoint of preventing bleed-out from the edges of the photosensitive film having the photosensitive resin composition layer, and from the viewpoint of development and soldering heat resistance.

The content of component (B) is preferably 10-70 parts by weight and more preferably 35-55 parts by weight with respect to 100 parts by weight as the total of components (A), (B) and (D). If the content is less than 10 parts by weight, the photosensitivity will tend to be insufficient, and if it is greater than 70 parts by weight the photocured photosensitive resin composition will tend to be brittle.

The content of component (D) is preferably 1-20 parts by weight and more preferably 5-15 parts by weight with respect to 100 parts by weight as the total of components (A), (B) and (D). If the content is less than 1 part by weight, the flexibility, soldering heat resistance and plating resistance will tend to be insufficient, while if the content is greater than 20 parts by weight, the coated film of the photosensitive resin composition will be prone to sticking. A larger content of component (D) will tend to increase the elongation percentage of the cured photosensitive resin composition, while also lowering the tensile modulus and tensile strength.

The content of component (C) is preferably 0.1-20 parts by weight and more preferably 0.2-10 parts by weight with respect to 100 parts by weight as the total of components (A), (B) and (D), from the viewpoint of photosensitivity and soldering heat resistance.

If necessary, the photosensitive resin composition may also contain a thermosetting component such as a melamine resin or isocyanate block polymer, a dye such as malachite green, a photo development agent such as tribromophenylsulfone or leucocrystal violet, a thermal development inhibitor, a plasticizer such as p-toluenesulfonamide, a phthalocyanine-based organic pigment such as phthalocyanine green or phthalocyanine blue, an azo-based organic pigment, or an inorganic pigment such as titanium dioxide, a filler composed of an inorganic pigment such as silica, alumina, talc, calcium carbonate or barium sulfate, an anti-foaming agent, a flame retardant, a stabilizer, a tackifier, a leveling agent, an antioxidant, an aroma, an imaging agent or the like, each in an amount of about 0.01-20 parts by weight with respect to 100 parts by weight as the total of components (A) and (B). When the photosensitive resin composition further contains component (D), this range is 0.01-20 parts by weight of each with respect to 100 parts by weight of as the total of components (A), (B) and (D). These additional components may be used either alone or in combinations of two or more. Also, an acrylic copolymer component or the like, other than component (A) or component (D), may also be used.

The photosensitive resin composition may, if necessary, be dissolved in a solvent such as methanol, ethanol, acetone, methyl ethyl ketone, methylcellosolve, ethylcellosolve, toluene, N,N′dimethylformamide or propyleneglycol monomethylether, or a mixture of these solvents, and coated as a solution with a solid portion of about 30-70 wt %.

A photosensitive element according to the invention will now be described.

The photosensitive element of the invention comprises a support and a photosensitive resin composition layer composed of a photosensitive resin composition of the invention formed on the support. A protective film covering the photosensitive resin composition may also be provided over the photosensitive resin composition layer.

The photosensitive resin composition layer is preferably formed by dissolving the photosensitive resin composition of the invention in the aforementioned solvent or solvent mixture to form a solution with a solid portion of about 30-70 wt %, and then coating the solution onto a support. The thickness of the photosensitive resin composition layer will differ depending on the purpose, but is preferably 10-100 μm and more preferably 20-60 μm, as the dry thickness after removal of the solvent by heating and/or hot-air blasting. A thickness of less than 10 μm will tend to hamper industrial coating, while a thickness of greater than 100 μm will tend to reduce the aforementioned effect exhibited by the invention, and especially will tend to reduce the flexibility and resolution.

The support of the photosensitive element may be, for example, a polymer film with heat resistance and solvent resistance, such as polyethylene terephthalate, polypropylene, polyethylene or polyester.

The thickness of the support is preferably 5-100 μm and more preferably 10-30 μm. A thickness of less than 5 μm will tend to result in cracking of the support when the support is released prior to development, while a thickness of greater than 100 μm will tend to reduce the resolution and flexibility.

A photosensitive element composed of two layers: a support and a photosensitive resin composition layer, or a photosensitive element composed of three layers: a support, a photosensitive resin composition layer and a protective film, may be stored as is, or it may be stored after winding up onto a core into the form of a roll, via the protective film.

The method of forming a resist pattern using a photosensitive element of the invention comprises, as necessary, a removal step in which the protective film is removed from the photosensitive element, a laminating step in which the photosensitive element is laminated onto a circuit-forming board, in the order of photosensitive resin composition layer/support, an exposure step in which active light rays are irradiated onto a prescribed section of the photosensitive resin composition layer, through the support if necessary, to form photocured sections on the photosensitive resin composition layer, and a developing step in which the photosensitive resin composition layer at the non-photocured sections is removed. The circuit-forming board is a board provided with an insulating layer and a conductor layer (made of copper, a copper-based alloy, nickel, chromium, iron or an iron-based alloy such as stainless steel, and preferably copper, a copper-based alloy or an iron-based alloy) formed on the insulating layer.

If necessary, the method for lamination in the laminating step following the removal step for removal of the protective film may involve contact bonding of the photosensitive resin composition layer on the circuit-forming board with heating. The atmosphere for this lamination is not particularly restricted, but the lamination is preferably carried out under reduced pressure from the standpoint of adhesion and shape-following properties. The lamination surface will normally be the conductor layer of the circuit-forming board, but it may instead be a surface other than the conductor layer. The heating temperature of the photosensitive resin composition layer is preferably 70-130° C., the contact bonding pressure is preferably about 0.1-1.0 MPa and the ambient pressure is preferably no greater than 4000 Pa, but there is no particular restriction to these conditions. Pre-heating of the circuit-forming board is unnecessary if the photosensitive resin composition layer is heated to 70-130° C. as mentioned above, but the circuit-forming board may be pre-heated for a further improved laminating property.

After completing lamination in this manner, prescribed sections of the photosensitive resin composition layer are exposed to active light rays in the exposure step to form photocured sections. The method of forming the photocured sections may be a method known as “artwork”, in which the active light rays are irradiated in an image fashion through a negative or positive mask pattern. If the support on the photosensitive resin composition layer is transparent, the active light rays may be irradiated directly thereon, but if it is non-transparent, the support must first be removed from the photosensitive resin composition layer before irradiation of the active light rays.

The light source for the active light rays may be a publicly known light source, for example, one which efficiently emits ultraviolet rays such as a carbon arc lamp, mercury vapor arc lamp, ultrahigh-pressure mercury lamp, high-pressure mercury lamp, xenon lamp or the like. There may also be used an efficient visible light-emitting lamp such as a photographic floodlight or sunlight lamp.

When the support remains on the photosensitive resin composition layer after exposure, the support is first removed and then development is performed in the developing step by removing the non-cured sections of the photosensitive resin composition layer by wet development, dry development or the like, to form a resist pattern. For wet development, a developing solution suitable for the photosensitive resin composition is used, such as an aqueous alkali solution, an aqueous developing solution, an organic solvent or the like, for development by a publicly known method such as, for example, spraying, reciprocal dipping, brushing or scrapping. The developing solution used is one which is safe, stable and satisfactory manageable, and for example, there may be used a dilute solution (1-5 wt % aqueous solution) of sodium carbonate at 20-50° C.

The resist pattern obtained by this forming method is preferably one used to form a flexible cured resin on a film-like base, and more preferably it is one used as a permanent mask formed on a film-like base. For example, when used as a FPC cover lay, the aforementioned developing step is preferably followed by ultraviolet irradiation with a high-pressure mercury lamp or heating, in order to improve the soldering heat resistance and chemical resistance as an FPC cover lay. When ultraviolet rays are irradiated, the irradiation dose may be adjusted as necessary, and for example, irradiation may be at a dose of about 0.2-10 J/cm². For ultraviolet irradiation it is not necessary to pre-heat the resist pattern, but the resist pattern may be pre-heated to 60-150° C. in order to further improve the soldering heat resistance and chemical resistance. When the resist pattern is heated, it is preferably heated in a temperature range of about 100-170° C. for about 15-90 minutes. Ultraviolet irradiation and heating may also be performed simultaneously, or either may be performed after the other.

The cover lay serves as a circuit protecting film after soldering on the board, while also exhibiting excellent flexibility and insulating properties, and is therefore effective as a permanent mask for an FPC board.

A board provided with a resist pattern (cover lay) in this manner is then used for mounting (by soldering or the like) of parts such as LSIs, and loaded into an electronic device such as a camera.

### EXAMPLES

### Examples

The present invention will now be explained in greater detail by examples, with the understanding that the invention is in no way limited to these examples.

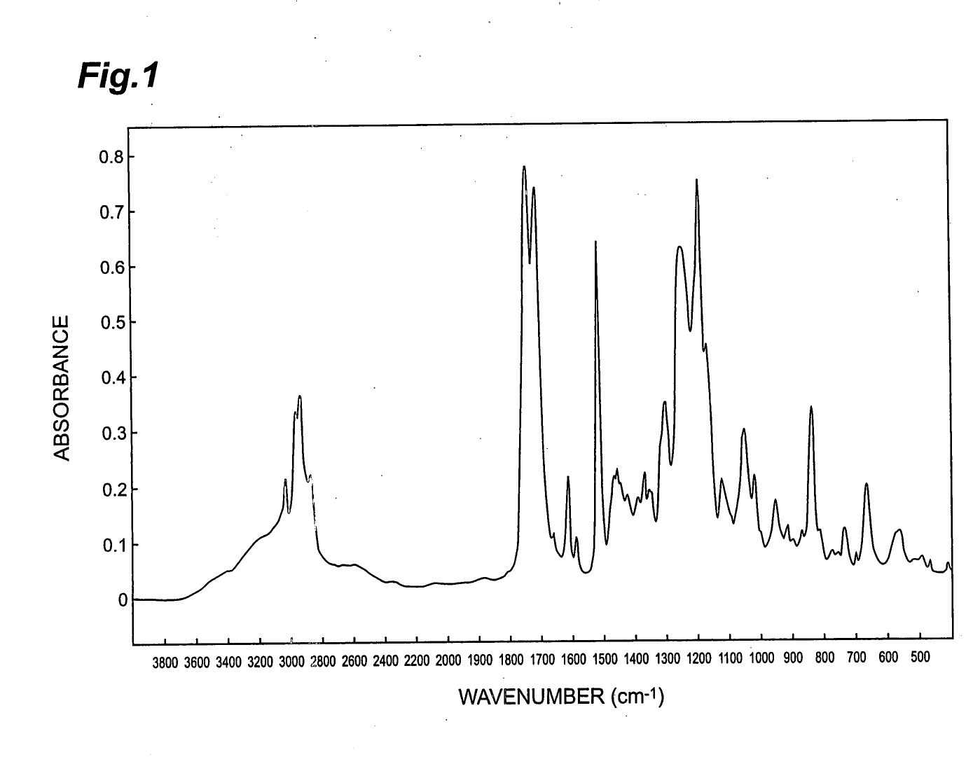

A modified epoxy resin as component (A) was prepared in the following manner. First, 182.7 parts by weight of a bisphenol A-type epoxy resin (EPIKOTE 1001, product of Japan Epoxy Resins, epoxy equivalents: 479 g/eq), 64.0 parts by weight of cyclohexanone and 30.0 parts by weight of toluene were charged into a flask equipped with a stirrer, a reflux condenser, a thermometer and a nitrogen gas inlet tube, and the mixture was stirred while heating at 130° C. and blowing in nitrogen gas, for reflux dehydration of the moisture in the epoxy resin. Next, 34.9 parts by weight of tetrahydrophthalic acid (product of New Japan Chemical Co., Ltd.) and 3.6 parts by weight of dimethylparatoluidine (product of Mitsuboshi Chemical Co., Ltd.) were added and the mixture was incubated for 4 hours at 140° C. After then adding 108.0 parts by weight of tetrahydrophthalic anhydride (New Japan Chemical Co., Ltd.), the mixture was incubated for 3 hours at 120° C. to obtain a modified epoxy resin as component (A). The modified epoxy resin was then diluted with 127.0 parts of methyl ethyl ketone. The weight-average molecular weight of the obtained modified epoxy resin was 49,000, the solid portion was 57.0% and the acid value was 133 mgKOH/g. The IR spectrum of the obtained modified epoxy resin is shown in FIG. 1. The IR spectrum was measured using an “FTS135” (Digilab Japan).

The weight-average molecular weight (Mw) of the modified epoxy resin was measured by gel permeation chromatography (GPC) (calculated using a standard polystyrene calibration curve), under the following conditions.

(GPC Conditions)

Pump: Hitachi L-6000 (product of Hitachi Laboratories)

Detector: Hitachi L-4000 UV (product of Hitachi Laboratories)

Column: Gelpack GL-S300MDT-5 (twin columns) (trade name of Hitachi Chemical Industry Co., Ltd.)

Column size: 8 mmφ×300 mm

Eluent: DMF/THF=1/1+0.06 M phosphoric acid+0.06 M lithium bromide

Sample concentration: 5 mg/1 mL

Injection volume: 5 μL

Pressure: 35 kgf/cm²

Flow rate: 1.0 mL/min

A urethane resin was then prepared by the following method as the constituent material for component (B). First, air was introduced into a flask equipped with a stirrer, a reflux condenser, a thermometer and an air inlet tube, and then 196.8 parts by weight of polycarbonate diol (PLACCEL CD205PL, product of Dicel Chemical Industries Co., Ltd., weight-average molecular weight: 500), 58.3 parts by weight of dimethylolbutanoic acid (product of Mitsubishi Chemical Co., Ltd.), 37.6 parts by weight of diethylene glycol (product of Nisso Maruzen Chemical Co., Ltd.), 148.1 parts by weight of 1,4-cyclohexanedimethanol monoacrylate (product of Mitsubishi Chemical Co., Ltd.), 0.55 part by weight of p-methoxyphenol (product of Wako Pure Chemical Industries Co., Ltd.), 0.55 part by weight of dibutyltin laurate (product of Tokyo Fine Chemical Co., Ltd.) and 110.2 parts by weight of methyl ethyl ketone were charged in and the mixture was heated to 65° C. while stirring under an air stream.

Next, 305.9 parts by weight of trimethylhexamethylene diisocyanate (VESTANAT TMDI, product of Huls, Japan) was charged into a dropping container and steadily added dropwise into the reactor over a period of 3 hours while maintaining a reactor temperature of 65±3° C. After the dropwise addition was complete, the dropping vessel was washed using 76.5 parts by weight of methyl ethyl ketone, and the washing solution was directly loaded into the reactor. After further incubation for 2 hours while stirring, the reactor temperature was increased to 75° C.

Stirred incubation at 75±3° C. was then continued until disappearance of the infrared absorption peaks for isocyanate groups were confirmed using an infrared spectrometer. The infrared absorption peaks for isocyanate groups disappeared approximately 6-8 hours after increasing the temperature to 75° C. Upon confirming disappearance of the peaks, the reactor temperature was lowered to 60° C., 9.3 parts by weight of methanol was added and incubation was carried out for 30 minutes at 60±3° C. Next, 56.4 parts by weight of methyl ethyl ketone was added to obtain a urethane resin-containing transparent solution. This was designated as resin (2). The solid portion of the urethane resin was 75.6%, the acid value was 22.2 mgKOH/g and the viscosity was 1810 mPa·s.

### Examples 1-4 and Comparative Examples 1-3

First, the components listed in Table 1 were mixed in the solid portion mixing ratios shown in the table (based on weight), to obtain photosensitive resin composition solutions. In the table, Resin (1) is a 65 wt % carbitol acetate/solvent naphtha solution of an acid-modified bisphenol A-type epoxy acrylate (ZAR-1035, trade name of Nihon Kayaku Co., Ltd.). Resin (3) is bisphenol A polyoxyethylene dimethacrylate (BPE-10, trade name of Shin-Nakamura Chemical Co., Ltd.), component (C) is 2-benzyl-2-dimethylamino-1-(4-morpholinophenyl)-butanone-1 (I-369, trade name of Ciba Specialty Chemical Co., Ltd.), and BL3175 is a 75 wt % methyl ethyl ketone solution containing a methyl ethyl ketone oxime block polymer of an isocyanurate comprising hexamethylene diisocyanate as the base isocyanate (BL3175, trade name of Sumika Bayer Urethane Co., Ltd.).

TABLE 1

| | | | | | | | | Comp. | Comp. | Comp. |
|---|---|---|---|---|---|---|---|---|---|---|
| | Example 1 | Example 2 | Example 3 | Example 4 | Example 5 | Example 6 | Example 7 | Ex. 1 | Ex. 2 | Ex. 3 |
| Component (A) | 100 | 100 | 100 | 100 | 90 | 80 | 70 | — | — | — |
| Resin (1) | — | — | — | — | — | — | — | 100 | 100 | 100 |
| Component (D) | — | — | — | — | 10 | 20 | 30 | — | — | — |
| Component (B) | | | | | | | | | | |
| Resin (2) | 53 | 67 | 67 | 57 | 57 | 57 | 57 | 53 | 67 | 67 |
| Resin (3) | 42 | 42 | 33 | 48 | 48 | 48 | 48 | 42 | 42 | 33 |
| Component (C) | 3 | 3 | 3 | 3 | 3 | 3 | 3 | 3 | 3 | 3 |
| Other | | | | | | | | | | |
| BL3175 | 20 | 20 | 20 | 20 | 20 | 20 | 20 | 20 | 20 | 20 |
| Phthalocyanine blue | 0.2 | 0.2 | 0.2 | 0.2 | 0.2 | 0.2 | 0.2 | 0.2 | 0.2 | 0.2 |
| Methyl ethyl ketone | 35 | 35 | 35 | 35 | 35 | 35 | 35 | 35 | 35 | 35 |

Note:
The values in Table 1 are the solid mixing ratios of each component (except for methyl ethyl ketone).
The symbol “—” in the table indicates that the component was not present.

### Examples 5-7

The components listed in Table 1 were mixed in the solid portion mixing ratios shown in the table (based on weight), to obtain photosensitive resin composition solutions. In the table, component (D) is a 40 wt % methyl ethyl ketone/propyleneglycol monomethyl ether solution of an unsaturated group-containing acrylic resin with a Tg of 12° C., a weight-average molecular weight of 50,000 and an acid value of 90 mgKOH/g (trade name “AP-29M” by Shin-Nakamura Chemical Co., Ltd.). Resin (2), Resin (3) and component (C) are the same as described above. The weight-average molecular weights of the obtained photosensitive resin compositions were measured under the GPC conditions listed above.

Each photosensitive resin composition solution was then evenly coated onto a 16 μm-thick polyethylene terephthalate film (G2-16, trade name of Teijin Corp.) as the support layer to form a photosensitive resin composition layer, which was then dried at 100° C. for about 10 minutes using a hot air convection drier. The film thickness of the dried photosensitive resin composition layer was 25 μm.

Next, a polyethylene film (NF-13, trade name of Tamapoly Co., Ltd.) was attached as a protective film on the surface of the photosensitive resin composition layer opposite the side in contact with the support layer, to obtain a photosensitive element.

The copper surface of a flexible printed circuit board base (F30VC1, trade name of Nikkan Industries Co., Ltd.) comprising an 18 μm-thick copper foil laminated on a polyimide base was polished with an abrasive brush, washed with water and dried. A continuous vacuum laminator (HLM-V570, trade name of Hitachi Chemical Industries Co., Ltd.) was used for lamination of the obtained photosensitive element onto the flexible printed circuit board base, while peeling off the polyethylene film, under conditions with a heat shoe temperature of 100° C., a laminating speed of 0.5 m/min, an air pressure of no greater than 4000 Pa and a contact bonding pressure of 0.3 MPa, to obtain a laminated body for evaluation.

[Evaluation of Photosensitivity]

A phototool with a Stouffer 21 step tablet was adhered as a negative onto the obtained laminated body for evaluation, and an HMW-201GX light exposure device by Oak Manufacturing Co., Ltd. was used for light exposure at an energy dose for 8.0 steps remaining after development with the Stouffer 21 step tablet. After subsequent standing for one hour at ordinary temperature, the PET film was released and a 1 wt % aqueous sodium carbonate solution at 30° C. was sprayed for a period of 60 seconds for development, prior to heating (drying) at 80° C. for 10 minutes. The aforementioned energy dose was used as the value for evaluation of the photosensitivity. A lower value indicates high photosensitivity. The results are shown in Table 2.

[Evaluation of Resolution]

A phototool with a Stouffer 21 step tablet, and a phototool bearing a wiring pattern with a line width/space width of 30/30-200/200 (units: μm) used as the negative for evaluation of resolution, were adhered onto a laminated body for evaluation, and the same light exposure device as above was used for light exposure at an energy dose for 8.0 steps remaining after development with the Stouffer 21 step tablet. After subsequent standing for one hour at ordinary temperature, the PET film was released and a 1 wt % aqueous sodium carbonate solution at 30° C. was sprayed for a period of 60 seconds for development, prior to heating (drying) at 80° C. for 10 minutes. The resolution was evaluated as the smallest value (units: μm) of the space width between lines for which development yielded a rectangular resist shape. A smaller value represents superior resolution. The results are shown in Table 2.

[Evaluation of Film Formability]

Without exposing the obtained laminated body for evaluation, the polyethylene terephthalate on the laminated body was released, the surface of the coating was lightly pressed with the finger, and the degree of sticking onto the finger was evaluated according to the following criteria. Specifically, “A” was assigned when no or virtually no sticking onto the finger was observed, and “B” was assigned when sticking onto the finger was observed. The results are shown in Table 2.

Also, a phototool with a Stouffer 21 step tablet, and a phototool bearing a wiring pattern as the negative for evaluation of the cover lay reliability, were adhered onto the laminated body for evaluation, and the same light exposure device as above was used for light exposure at an energy dose for 8.0 steps remaining after development with the Stouffer 21 step tablet. After subsequent standing for one hour at ordinary temperature, the polyethylene terephthalate film on the laminated body was released, spray developing was performed with the same developing solution and conditions as for evaluation of the sensitivity, and heating (drying) was carried out at 80° C. for 10 minutes. Next, an UV light exposure device by Oak Manufacturing Co., Ltd. was used for UV light exposure at an energy dose of 1 J/cm², and further heat treatment was carried out at 160° C. for 60 minutes to obtain an FPC board for evaluation having a cover lay formed thereon.

[Evaluation of Soldering Heat Resistance]

After coating rosin-based flux (MH-820V, trade name of Tamura Kaken Corp.) onto the FPC for evaluation which was obtained in the manner described above, it was dipped for 30 seconds in a soldering bath at 260° C. for soldering treatment.

Upon visual examination of the generation of crack on the cover lay of the FPC board which had been solder plated in this manner, and the extent of bumps and peeling of the cover lay from the base, evaluation was conducted according to the following criteria. Specifically, “A” was assigned when no crack was found on the cover lay and no bumps or peeling were found on the cover lay, and “B” was assigned when either was found. The results are shown in Table 2.

[Plating Resistance]

The obtained FPC for evaluation was dipped for 15 minutes in a plating bath at 85° C. containing an electroless nickel plating solution (MELPLATE NI-865T, trade name of Meltex Inc.), and then was dipped for 10 minutes in a plating bath at 90° C. containing an electroless gold plating solution (MELPLATE AU-601, trade name of Meltex Inc.), for plating treatment.

Upon visual examination of the generation of crack on the cover lay of the FPC board which had been subjected to electroless nickel-gold plating in this manner, and the extent of bumps and peeling of the cover lay from the base, evaluation was conducted according to the following criteria. Specifically, “A” was assigned when no crack was found in the cover lay and no bumps or peeling were found on the cover lay, and “B” was assigned when either was found. The results are shown in Table 2.

[Evaluation of Folding Strength (Flexibility)]

The obtained FPC for evaluation was bent 180° by lock bending and the generation of crack in the cover lay during the test was visually observed and evaluated according to the following criteria. Specifically, “A” was assigned when no crack was found in the cover lay, and “B” was assigned when crack was found. The results are shown in Table 2.

[Evaluation of Tensile Modulus, Tensile Strength and Elongation]

The tensile modulus, tensile strength and elongation were measured according to JIS K 7127, “Plastic Film and Sheet Tensile Test Methods”. The results are shown in Table 2.

TABLE 2

| | | | | | | | | Comp. | Comp. | Comp. |
|---|---|---|---|---|---|---|---|---|---|---|
| Property | Example 1 | Example 2 | Example 3 | Example 4 | Example 5 | Example 6 | Example 7 | Ex. 1 | Ex. 2 | Ex. 3 |
| Photosensitivity (mJ/cm²) | 170 | 170 | 190 | 170 | 200 | 200 | 200 | 150 | 150 | 150 |
| Resolution (μm) | 50 | 50 | 60 | 50 | 50 | 50 | 50 | 40 | 40 | 50 |
| Film formability | A | A | A | A | A | A | A | B | B | B |
| Soldering heat resistance | A | A | A | A | A | A | A | A | A | A |
| Electroless gold plating resistance | A | A | A | A | A | A | A | A | A | A |
| Bending resistance (flexibility) | A | A | A | A | A | A | A | B | B | B |
| Tensile modulus (GPa) | — | — | — | 1.35 | 1.22 | 1.08 | 0.97 | — | — | — |
| Tensile strength (MPa) | — | — | — | 41.9 | 40.4 | 36.1 | 31.1 | — | — | — |
| Elongation (%) | — | — | — | 4.2 | 5.9 | 6.7 | 7.8 | — | — | — |

Note:
The symbol “—” in Table 2 indicates non-evaluated or immeasurable cases.

As is clear from Table 2, the laminated bodies employing the photosensitive resin compositions of Examples 1-7 exhibited sufficiently excellent photosensitivity, resolution and film formability. The FPC boards obtained using these laminated bodies also were confirmed to have sufficiently excellent flexibility. In addition, the FPC boards employing photosensitive resin compositions of Examples 5-7, which contained component (D), were demonstrated to have superior plating resistance.

### INDUSTRIAL APPLICABILITY

According to the present invention, it is possible to provide a modified epoxy resin that can be used to prepare a photosensitive resin composition capable of simultaneously satisfying the properties required of permanent masks formed on film-like base materials such as FPC cover lays (especially photosensitivity, resolution, film formability, soldering heat resistance, plating resistance and flexibility), as well as a process for its production and a photosensitive resin composition comprising it. The invention also provides a photosensitive element comprising the photosensitive resin composition.

1. A modified epoxy resin containing a repeating unit represented by the following general formula (1): 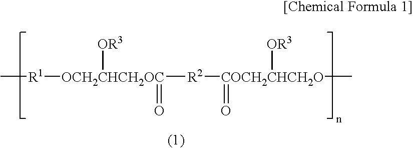
[wherein R¹ represents a divalent organic group which is a diglycidyl ether-type epoxy compound residue, R² represents a divalent organic group which is a dibasic acid residue, R³ represents a hydrogen atom or a group represented by the following general formula (2): 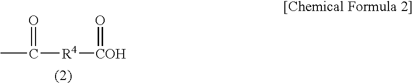
(wherein R⁴ represents an acid anhydride residue),
and n represents an integer of 1 or greater].

2. A modified epoxy resin represented by the following general formula (3): 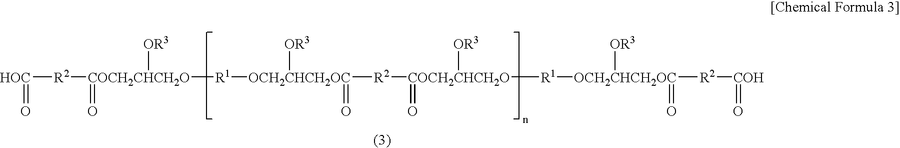
[wherein R¹ represents a divalent organic group which is a diglycidyl ether-type epoxy compound residue, R² represents a divalent organic group which is a dibasic acid residue, R³ represents a hydrogen atom or a group represented by the following general formula (4): 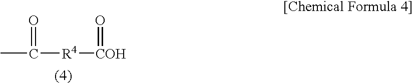
(wherein R⁴ represents an acid an hydride residue),
and n represents an integer of 1 or greater].

3. A modified epoxy resin obtained by a production process for a modified epoxy resin which comprises
a first step of obtaining an intermediate product by polymerization reaction between a diglycidyl ether-type epoxy compound and a dibasic acid, and
a second step of adding an acid anhydride to said intermediate product.

4. A modified epoxy resin according to claim 1, wherein said dibasic acid is a dicarboxylic acid,
and has a linear structure due to ester bonds produced by reaction between carboxyl groups and glycidyl groups in the molecule.

5. A modified epoxy resin according to claim 1, which has at least one carboxyl group, and has a weight-average molecular weight of 10,000-70,000.

6. A modified epoxy resin according to claim 1, which has a weight-average molecular weight of 10,000-70,000.

7. A modified epoxy resin according to claim 1, which has an acid value of 70-200 mgKOH/g.

8. A production process for a modified epoxy resin which comprises
a first step of obtaining an intermediate product by polymerization reaction between a diglycidyl ether-type epoxy compound and a dibasic acid, and
a second step of adding an acid anhydride to said intermediate product to obtain a modified epoxy resin.

9. A production process for a modified epoxy resin according to claim 8, wherein a dicarboxylic acid is used as said dibasic acid.

10. A production process for a modified epoxy resin according to claim 8, wherein said polymerization reaction in said first step is carried out using a tertiary amine with a pKa of no greater than 9.0 as the catalyst.

11. A photosensitive resin composition comprising (A) a modified epoxy resin according to claim 1, (B) a photopolymerizable compound having at least one ethylenic unsaturated group in the molecule, and (C) a photopolymerization initiator.

12. A photosensitive resin composition according to claim 11, which further comprises (D) a resin with an unsaturated group, obtained by polymerization of
(a) a resin obtained by copolymerization of a (meth)acrylic acid ester monomer and a monomer with a prescribed functional group (I), and
(b) a compound with a prescribed functional group (II) and an unsaturated group,
by reaction between said functional group (I) and said functional group (II).

13. A photosensitive resin composition according to claim 12, wherein said functional group (I) is at least one selected from the group consisting of hydroxyl, carboxyl, epoxy and isocyanate.

14. A photosensitive resin composition according to claim 12, wherein the monomer containing said functional group (I) is at least one selected from the group consisting of 2-hydroxyethyl (meth)acrylate, 2-hydroxypropyl (meth)acrylate, 4-hydroxybutyl (meth)acrylate, phenylglycidylether (meth)acrylate, (meth)acrylic acid, itaconic acid, β-(meth)acryloyloxyethylhydrogen succinate, glycidyl (meth)acrylate, (meth)allylglycidyl ether, vinyl isocyanate, (meth)acryl isocyanate and 2-(meth)acryloyloxyethyl isocyanate.

15. A photosensitive resin composition according to claim 12, wherein said functional group (II) is at least one selected from the group consisting of aldehyde, hydroxyl, ethyleneimino, carboxyl, epoxy and isocyanate.

16. A photosensitive resin composition according to claim 12, wherein the unsaturated group of said (b) compound with a prescribed functional group (II) and an unsaturated group is at least one selected from the group consisting of vinyl, isopropenyl, (meth)allyl and (meth)acryloyl.

17. A photosensitive resin composition according to claim 12, wherein the combination of said functional group (I) and said functional group (II) is a combination selected from the group consisting of hydroxyl and isocyanate, hydroxyl and epoxy, hydroxyl and aldehyde, hydroxyl and carboxyl, hydroxyl and ethyleneimino, carboxyl and epoxy, carboxyl and hydroxyl, isocyanate and hydroxyl, and epoxy and carboxyl.

18. A photosensitive resin composition according to claim 12, wherein the glass transition temperature of the (D) resin with an unsaturated group is −10 to 60° C., the weight-average molecular weight is 10,000-200,000 and the acid value is 50-150 mgKOH/g.

19. A photosensitive resin composition comprising (A) a modified epoxy resin, (B) a photopolymerizable compound having at least one ethylenic unsaturated group in the molecule, and (C) a photopolymerization initiator, wherein said component (A) is a modified epoxy resin according to claim 2.

20. A photosensitive resin composition according to claim 11, which is used to form a flexible cured resin on a film-like base.

21. A photosensitive resin composition according to claim 11, which is used to form a permanent mask for a flexible printed circuit board.

22. A photosensitive element comprising a support and a photosensitive resin composition layer composed of a photosensitive resin composition according to claim 11 formed on said support.

23. A modified epoxy resin according to claim 3, wherein said dibasic acid is a dicarboxylic acid,
and has a linear structure due to ester bonds produced by reaction between carboxyl groups and glycidyl groups in the molecule.

24. A modified epoxy resin according to claim 3, which has at least one carboxyl group, and has a weight-average molecular weight of 10,000-70,000.

25. A modified epoxy resin according to claim 3, which has a weight-average molecular weight of 10,000-70,000.

26. A modified epoxy resin according to claim 3, which has an acid value of 70-200 mgKOH/g.

27. A photosensitive resin composition comprising (A) a modified epoxy resin according to claim 3, (B) a photopolymerizable compound having at least one ethylenic unsaturated group in the molecule, and (C) a photopolymerization initiator.

28. A photosensitive resin composition according to claim 27, which further comprises (D) a resin with an unsaturated group, obtained by polymerization of
(a) a resin obtained by copolymerization of a (meth)acrylic acid ester monomer and a monomer with a prescribed functional group (I), and
(b) a compound with a prescribed functional group (II) and an unsaturated group,
by reaction between said functional group (I) and said functional group (II).

29. A photosensitive resin composition according to claim 28, wherein said component (A) is a modified epoxy resin according to claim 2.

30. A photosensitive resin composition according to claim 27, wherein said component (A) is a modified epoxy resin according to claim 2.

31. A photosensitive resin composition according to claim 12, wherein said component (A) is a modified epoxy resin according to claim 2.

32. A photosensitive element comprising a support and a photosensitive resin composition layer composed of a photosensitive resin composition according to claim 28 formed on said support.

33. A photosensitive element comprising a support and a photosensitive resin composition layer composed of a photosensitive resin composition according to claim 27 formed on said support.

34. A photosensitive element comprising a support and a photosensitive resin composition layer composed of a photosensitive resin composition according to claim 12 formed on said support.
